(19) United States
(12) Patent Application Publication
(10) Pub. No.: US 2020/0248755 A1
(43) Pub. Date: Aug. 6, 2020

(54) CLUTCH DEVICE

(71) Applicant: KTM AG, Mattighofen (AT)

(72) Inventors: Paul Achtsnit, Weitersfeld (AT); Jun Miyazaki, Tokyo (JP)

(21) Appl. No.: 16/775,473

(22) Filed: Jan. 29, 2020

(30) Foreign Application Priority Data
Feb. 4, 2019 (DE) 10 2019 102 647.4

(51) Int. Cl. F16D 13/50; B60K 23/02

(52) U.S. Cl. CPC F16D 13/50; B60Y 2200/12; B60K 23/02

(57) ABSTRACT

A clutch apparatus for a vehicle drive train for transmitting torque between the vehicle's engine and gearbox. Three interoperative clutch members are provided. The clutch members cooperate with clutch plates, a pressure-receiving plate, a clutch pressure plate, clutch pressure springs, and a setting device between the second and the third clutch members, for setting a back torque between the third and first clutch members by an axial displacement of the third clutch member relative to the second clutch member. The setting device has two ring elements, which are rotatable n relation to each other, with ramp segments, and having balls arranged between the ramp segments; the ramp segments have regions with ball that rise or slope in opposite directions in such a way that when the ring elements rotate in the same direction, the distance between the ramp segments is smaller than when the ring elements rotate in opposite directions.

### CROSS-REFERENCE TO RELATED APPLICATIONS

This application claims priority to German Patent Application No. DE 10 2019 102 647.4, filed 4 Feb. 2019, the contents of which are incorporated herein by reference.

### BACKGROUND OF THE INVENTION

### Field of the Invention

The present invention relates to a clutch device for a vehicle, which is intended to be arranged in a drive train for transmitting torque between a drive engine and a gear change gearbox of the vehicle.

### Background Information

The clutch system provided hereby has an apparatus for limiting a back torque or reverse torque. Such a reverse torque occurs when a vehicle, which may be a motorcycle, fitted with the clutch apparatus of the invention is operated in the overrun or thrust mode. In the overrun mode and for torque transmission in a closed drive train, the drive engine of the vehicle generates a thrust or braking torque which is transmitted via the drive train to a drive wheel of the vehicle. In a single-track vehicle, such as a motorcycle, the driving forces have a significant influence on the driving behavior of the vehicle, so that due to this back-torque the driving behavior of the vehicle is significantly influenced.

A user of the vehicle may, by actuating a known clutch device between the propulsion or drive engine and the gear change transmission to open the clutch device and thus the driveline, exert some influence on the effect of the reverse torque on driving behavior. But such influence cannot be done in a reproducible manner, because this requires the setting of a predefined slip condition in a clutch plate pack of the known clutch device by means of the setting of an air gap, which cannot be achieved in a recurring, reproducible manner by the user actuating the clutch device (with, for example, a clutch actuating lever.) The user cannot actuate the clutch within the required narrow tolerance range of the air gap of the clutch.

To prevent any possible negative influence on the vehicle's performance, while at the same time allowing the generation of a certain braking torque desired by the driver of the vehicle, it is therefore necessary to provide a clutch device which allows the transmission of a reproducible and preferably adjustable braking torque or thrust torque via the drive train. Such a clutch device has also come to be known as an “anti-hopping” clutch, and is intended to prevent the rear wheel from stamping or locking, especially when the motorcycle is in overrun. This locking can occur, for example, when the gear change gearbox is shifted down when approaching a bend, in order to engage a lower gear or gear step and, after traction in the lower gear step, a high engine braking torque is produced which can lead to the rear wheel locking. Rear wheel locking, by its very nature, can lead to a fall when the motorcycle is in a sloping position while cornering.

In such a situation, even the actuation (by the user of the vehicle) of the starting clutch normally provided in the driveline or drive train can no longer have a positive influence on driving behavior. It also is noted that on sports motorcycles or competition motorcycles the gear change is normally carried out without the actuation of the starting clutch. The starting clutch is mainly provided for starting the stationary vehicle. During operation, the gear change is normally carried out without actuating of the starting clutch in order to maintain torque transmission, as it were, without interruption of the power flow in the drive train; the gear changes are carried out, for example, during a very brief interruption in the ignition of the drive engine, or a brief increase in the throttle valve angle.

If a drive engine of the vehicle (e.g., in the form of an internal combustion engine) is to be started by means of an external starting device by applying starting torque to the drive wheel with the drive train closed and the gear engaged by means of the external starting device, or if the vehicle is pushed to start the drive engine, the clutch device provided in the drive train is closed for torque transmission. During these types of starting processes, a reverse torque corresponding to the thrust operation of the engine acts, but this torque is required to start the engine and must therefore be transmitted safely.

To meet both requirements, such a clutch device must therefore provide, on the one hand, for automatic closing of the disk pack and keeping it closed (in order to be able to start the drive motor) and, on the other hand, must also provide an air gap for the clutch package to limit the braking torque transmitted by the drive train. The braking torque needs to be limitable so that when a predetermined reverse torque occurs, the air gap is provided to slightly open the clutch package, to provide a predefined slip condition in the clutch package. The predefined slip condition is desired so that the reverse torque does not increase above the predetermined value, and so that the driving behavior of the vehicle is not negatively affected by an uncontrolled increase of the reverse torque.

On the basis of EP 2 927 525 A1, a clutch device has already become known which has a device for limiting the reverse torque. This known device displaces a clutch pressure plate in a direction away from a clutch hub when a reverse torque occurs, and comprises a device which limits the movement of the clutch pressure plate in the direction away from the clutch hub when the number of revolutions of an output shaft of the clutch device is less than a predetermined value.

On the basis of EP 3 054 186 A1, a generic clutch device has become known which has an engagement device which is provided to bring about a releasable engagement position as a function of the rotational angular velocity of the clutch device, with several pin bodies arranged in receiving bores and in pretension in the direction of the engagement position by means of a respective compression spring. The pin bodies disclosed in EP 3 054 186 A1 with the reference mark 42 can be displaced radially, in pretension by a helical compression spring, in one direction at 90 degrees to the longitudinal center axis C2 of the clutch device to bring about a positive connection with the clutch hub, and also in the opposite direction to enable the plate pack or clutch package to be released when a reverse torque occurs. The locating bores therefore run at a 90-degree angle to the clutch hub, and must therefore be drilled from the outside during production using a drilling tool. After inserting the respective pin body and the helical compression spring, the bore, which is therefore open to the outside, must be closed by means of a closing body inserted with a fit. In this device, the clutch device rotates at high speed during operation of the internal combustion engine, which can lead to the problem that, due to the high centrifugal forces involved, the sealing body is subjected to a high centrifugal force and therefore the problem arises that the sealing body can come loose from the receiving bore. Furthermore, the necessity of using such closure bodies represents a need for additional manufacturing steps, thus increasing the manufacturing effort and the need for additional components.

An anti-hopping clutch dating back to Suter Racing Technology AG has also been made known, in which a hub carrier is rotated against an inner basket of the clutch and balls supported against an insert act on a ring which performs an axial movement, thereby slightly opening the plate pack to allow a predetermined braking torque but preventing uncontrolled locking or stamping of the drive wheel. Although this well-known clutch has already proven itself in practice, there is still room for improvement, especially in the area of reducing the breakaway torque of the axially displaceable clutch members to provide the anti-hopping function, in order to achieve a finer adjustment of the permissible back torque and to avoid that the clutch only opens at a high torque peak of the back torque to provide the anti-hopping function. From the foregoing, the present invention was developed to create an improved clutch apparatus which, on the one hand, can be produced more easily and cheaply and, on the other hand, has less breakaway torque when the anti-hopping function is activated. The invention created to solve this problem has the features indicated in the claims.

### SUMMARY OF THE INVENTION (DISCLOSURE OF THE INVENTION)

There is provided a clutch apparatus for a vehicle, intended to be arranged in a drive train for transmitting torque between a drive engine and a gear change gearbox of the vehicle. The clutch apparatus includes an engagement device, between a second clutch member and a third clutch member, for accomplishing an engagement position between the second clutch member and the third clutch member which is releasable as a function of the rotational angular velocity of the third clutch member.

The apparatus has a first clutch member, which is intended for coupling with the output side of the drive engine; a second clutch member having a longitudinal central axis, which member is for coupling with the gear change gearbox; a third clutch member, axially displaceable and rotatable relative to the second clutch member, and having an inner recess with a longitudinal center axis corresponding or coincident to the longitudinal center axis of the second clutch member; at least one first clutch plate, rotatably provided together with the first clutch member, and axially displaceable relative thereto; at least one second clutch plate, provided together with the third clutch member so as to be rotatable and axially displaceable relative thereto, and which has an overlapping arrangement with the first clutch plate; a pressure-receiving plate on the second clutch member for supporting the assembly of the first and second clutch plates; a clutch pressure plate, adjacent to the second clutch member, for pressurizing the arrangement of the first and second clutch plates; a plurality of clutch pressure springs provided for pressurizing the clutch pressure plate relative to the pressure receiving plate; and a setting device, between the second clutch member and the third clutch member, for adjusting a back torque between the third clutch member and the first clutch member by an axial displacement of the third clutch member relative to the second clutch member.

The clutch apparatus also includes an engagement device, between the second clutch member and the third clutch member, for accomplishing an engagement position between the second clutch member and the third clutch member which is releasable as a function of the rotational angular velocity of the third clutch member. The engagement device has at least one pin body with a longitudinal central axis, which pin body is arranged displaceably in a receiving bore of the third clutch member and is prestressed or biased in the direction of the engagement position by a compression spring; the longitudinal central axis of the pin body coincides or is coaxial with a longitudinal central axis of the receiving bore.

The engagement device also includes first and second ring elements rotatable relative to one another, the ring elements provided with ramp segments with balls arranged between the ramp segments. The ramp segments include regions with ball ramps, so formed with the ball ramps rising in opposite circumferential directions so that when the ring elements are rotated in the same direction, the clearance distance between the ramp segments is smaller than when the ring elements are rotated in opposite directions.

### BRIEF DESCRIPTION OF THE SEVERAL VIEWS OF THE DRAWING

The invention is explained in more detail below on the basis of the drawing. This is shown in:

FIG. 1 is a longitudinal sectional view of an embodiment of a clutch device according to the present invention;

FIG. 2 is another, enlarged, longitudinal section view similar to that shown in FIG. 1;

FIG. 3 is a top view of the clutch device, from the side of a disengaging device, for opening the clutch and for explanation of the sectional view path according to FIG. 1, and the sectional view IV-IV of FIG. 4;

FIG. 4 a sectional view according to the sectional view path IV-IV according to FIG. 3;

FIG. 5 is a longitudinal sectional view of the third clutch member;

FIG. 6 is a view of the third clutch member according to view at VI-VI as shown in FIG. 5;

FIGS. 7A, 7B, and 7C are three sectional views of the second clutch member;

FIGS. 8A, 8B, and 8C are three views of a first ring element which can be coupled non-rotatably with the third clutch member, FIG. 8C being a cross sectional view of a first ring element;

FIGS. 9A, 9B, and 9C are three views of a second ring element which can be coupled non-rotatably with the second clutch member, FIG. 9C being a cross sectional view of a second ring element;

FIG. 10 is a perspective view showing the sleeve body in an axially fixed position on a ring element;

FIG. 11 is a top view showing a position of balls arranged on a ring element during the transmission of drive torque;

FIG. 12 is a view similar to that shown in FIG. 11, showing the position of balls arranged on the ring element when the anti-hopping function of the invention is activated;

FIG. 13 is a schematic diagram of a motorcycle, having a front wheel and a rear wheel and a drive motor, equipped with the clutch device according to the invention; and

FIG. 14 a sectional view to explain the device for setting the back torque between the second clutch member and the first clutch member.

### DETAILED DESCRIPTION OF THE INVENTION

The present invention provides a specialized clutch apparatus for a vehicle, particularly but not necessarily for a motorcycle, which is intended to be arranged in a drive train for transmitting torque between a drive engine and a gear change gearbox of the vehicle. The clutch apparatus includes an engagement device, between a second clutch member and a third clutch member, for accomplishing an engagement position between the second clutch member and the third clutch member which is releasable as a function of the rotational angular velocity of the third clutch member.

The clutch apparatus and system have a first clutch member, which is to be coupled with the output side of the drive engine, and a second clutch member for coupling with the gear change gearbox. The clutch device also includes a third clutch member that is axially displaceable and rotatable in relation to the second clutch member. The third clutch member has an inner recess with its longitudinal center axis corresponding or coaxial with a longitudinal center axis of the second clutch member. There is at least one first clutch plate, rotatably provided together with the first clutch member and axially displaceable relative thereto. At least one second clutch plate is provided together with the third clutch member so as to be rotatable and axially displaceable relative thereto, and which has an overlapping arrangement with the first clutch plate. A pressure-receiving plate is associated with the second clutch member for supporting an assembly of the first and second clutch plates. A clutch pressure plate, adjacent to the second clutch member, pressurizes the arranged assembly of the first and second clutch plates; a plurality of clutch pressure springs also are provided for pressurizing the clutch pressure plate relative to the pressure receiving plate. A setting device, situated between the second clutch member and the third clutch member, allows for adjusting a back torque between the third clutch member and the first clutch member by an axial displacement of the third clutch member relative to the second clutch member.

The clutch device according to this disclosure also includes an engagement device, between the second clutch member and the third clutch member, for accomplishing an engagement position or condition between the second clutch member and the third clutch member. The engagement is releasable as a function of the rotational angular velocity of the third clutch member. The engagement device has at least one pin body with a longitudinal central axis, which pin body is arranged displaceably in a receiving bore of the third clutch member and is biased in the direction of the engagement position by a compression spring. The longitudinal central axis of the pin body coincides or is coaxial with a longitudinal central axis of the receiving bore. The engagement device also includes first and second ring elements rotatable relative to one another, the ring elements provided with ramp segments with balls arranged between the ramp segments. The ramp segments include regions with ball ramps; the ball ramps rising in opposite circumferential directions so that when the ring elements rotate in the same direction, the clearance distance between the ramp segments is smaller than when the ring elements rotate in opposite directions.

The forgoing configuration for this clutch device ensures that an opposite rotation of the ring elements relative to each other, which occurs when a reverse torque occurs in the drive train of the vehicle provided with the clutch device, induces to an axial displacement of the two ring elements relative to each other. Such axial displacement is provided for the axial displacement of the third clutch member to bring about a predetermined slip condition in the clutch plates pack of the clutch device. The relative rotation of the ring elements in opposite directions ensures that the balls arranged between the ramp segments roll on the ball ramps formed in the opposite direction, and thus cause an axial displacement of the ring elements, which is translated into an axial displacement of the third clutch member.

For this purpose, the ring elements are supported on the one hand on the second clutch member and on the other hand on the third clutch member. An axial displacement of the ring elements thus increases in the relative distance between the two clutch members mentioned, and the third clutch member accordingly is displaced relative to the second clutch member. Because the relative rotation of the two ring elements due to the rolling condition at the ball ramps results in a displacement movement of the balls in the rolling regions, a further aspect of the invention is that at least one ring element, in the region of the ball ramps, has segments arranged radially outward, extending along a respective partial region of the circumferential extent of the ball ramps and projecting in the height direction of the ring element. These segments ensure that the balls find an abutment surface as they move along the ball ramps, and prevent the balls from escaping from the area of the ball ramps.

According to a further aspect of the invention, the ring elements are provided with engagement elements on spaced-apart rear surfaces of the elements, which are intended for engagement in corresponding recesses of the second and third clutch member, which recesses are complementary in shape and contour. Such a configuration ensures that the ring elements can each take up a positive engagement position with the second and third clutch member associated with the respective ring element, thereby providing a rotationally fixed configuration between the respective ring element and the respective clutch member.

By arranging locating bores in the axially displaceable third clutch member in such a way that the longitudinal center axis of each locating bore (holding a pin body) forms an internal angle of less than 90 degrees with the longitudinal center axis of the internal recess of the third clutch member, the locating bore advantageously can be machined starting from the internal recess and proceeding radially outward; it is possible in this way to form the receiving bore in the third clutch member in such a way that a blind bore is created to receive the pin body and the compression spring acting upon it, without having to close it in the radially outward direction by means of a closing body, plug, or the like.

Additionally, by changing or predetermining the size of the internal angle, the centrifugal force applied to the pin body can be influenced. If the internal angle is increased, a greater centrifugal force acts in the radial direction at a predetermined clutch device speed than at a smaller internal angle, which can be used, for ex-ample, to influence the opening behavior of the engagement device. Such an influence can be beneficial, for example, depending on the stroke volume or number of cylinders of the drive engine or the operating conditions prevailing at the time of starting the drive engine, such as the ignition angle. It can also be influenced, from which speed of the clutch device and thus the rotational angular velocity acting on the pin body or bodies, the engagement position of the engagement device is brought about with decreasing rotational angular velocity by the inward action of the pin body or bodies, and thus the positive locking position of the engagement device is brought about.

In the abovementioned, well-known, anti-hopping clutch from Suter Racing Technology AG, to release the clutch to activate its anti-hopping function, it is necessary that, by rotating an insert provided with ramp surfaces (ramp insert) relative to a hub carrier, ball bodies resting on the ramp surfaces are radially displaced, which in turn leads to an axial displacement of a release ring, which in turn presses on a torque limiting spring. This results that the back torque, from which the known clutch releases the release path to provide the slip condition, is strongly dependent on the speed, because the rotational inertia torque is dependent on the speed—thus no driving behavior perceived as constant by the driver (of the vehicle equipped with the Suter Racing Technology device) is achieved.

The clutch device according to the present invention provides a remedy for the foregoing problem. In the present clutch device, to activate the anti-hopping function, only the third clutch member must be displaced axially relative to the second clutch member, thus reducing the breakaway torque on the one hand and eliminating the strong speed dependency described above on the other.

According to an aspect of the present clutch device, the pin body is arranged such that the longitudinal central axis of the pin body encloses an internal angle of less than 90 degrees with the longitudinal central axis of the second clutch member, and preferably encloses an angular range of 50 degrees to 80 degrees respectively inclusive. This angular range has proved to be advantageous on the one hand with regard to the production of the locating bore for the respective pin body, and on the other hand also for the behavior of the pin bodies with regard to their displacement in the respective locating bore (as a function of the rotational angular speed of the clutch device).

According to a further aspect of the invention, it is also provided that the receiving bore is provided with a passage at the radially outer area (starting from the inner recess), which is intended for the passage of lubricant; but the radially outer area at the bottom of the bore prevents the passage or movement of the pin body, as well as the compression spring acting on the pin body, through the passage. This configuration creates the possibility that lubricant entering the locating bore can escape to the outside through the respective passage in the locating bore, thus preventing a lubricant cushion from building up underneath the pin body in the locating bore. Such a lubricant cushion would in fact influence the displacement behavior of the respective pin body in the receiving bore, depending on the volume of lubricant located in the receiving bore between the bottom of the bore and the pin body—thus ensuring that the opening behavior of the engagement device would be different depending on the volume of lubricant in the respective receiving bore. The clutch device according to this invention thus also provides a remedy, and ensures that the pin bodies are displaced as intended and thus the engagement position of the engagement device is released as intended.

It is also provided, according to another aspect of the invention, that a plurality of pin bodies are arranged on a hub of the third clutch member, starting from the inner recess, and can be brought into releasable engagement with engagement recesses arranged on a hub of the second clutch member. These pin bodies, also known as starter pins, six of which can be arranged in six locating bores, for example, are arranged equidistantly in the circumferential direction on the hub of the third clutch member. This arrangement ensures that the external starting torque transmitted to the engine during the starting process of the drive motor is distributed evenly into the engagement recesses of the hub of the second clutch member.

It is also provided, according to yet another aspect of the invention, that each respective engagement recess is provided with an entry or lead-in chamfer, which is provided on an outer surface of the hub, and formed at an angle to the longitudinal center axis of the second clutch member. The chamfer merges into a stop surface of the engagement recess. The respective lead-in chamfer(s) ensures that the starter pin bodies, when moving in the direction of the engagement position of the engagement device, i.e. when moving in the locating bore from radially outside toward radially inside, experience a gentle engagement movement with the respective engagement recess guided by the lead-in chamfer; thus the surface pressure at the transition of the pin bodies to the stop surface of the engagement recess is reduced. This movement of the pin bodies from the outside inwards takes place at a predetermined angular speed of rotation of the clutch device, for example when the drive motor is switched off and the limit speed is reached during the deceleration process of the clutch device—at which point the pin bodies are pressed radially inwards by a respective compression spring.

There also is provided, according to a further aspect of the invention, that the third clutch member has shaped surfaces arranged at an angle to a cross-sectional plane extending at right angles to the longitudinal central axis. These first shaped surfaces of the third clutch member are in engagement with other shaped surfaces provided at an angle to the second clutch member in such a way that, during the pulling operation of the clutch device, a force is generated which acts on the third clutch member in the direction of the second clutch member. This configuration ensures that the undercut thus formed in the area of the shaped surfaces of the third clutch member causes a force to be exerted on the third clutch member in the direction of the second clutch member by the transmission of torque during traction operation of the clutch device; i.e., during the transmission of torque from the drive engine in the direction of the rear wheel of the vehicle, which counteracts unintentional separation of the third clutch member from the second clutch member.

It is also provided, according to another aspect of the invention, that the third clutch member has a cylinder-segment-shaped hub body, on the outer circumference of which a plurality of longitudinal grooves are formed in the shape of arcs or segments of a circle (in a cross-sectional view of the hub body), which are provided for receiving hollow cylindrical sleeves, on the outer surfaces of which the second clutch plates are arranged so as to be axially displaceable. This configuration ensures that the clutch plates rest on the hollow cylindrical sleeves during their axial displacement, thus increasing the contact surface between the clutch plates and the third clutch member compared to a configuration in which the clutch plates are placed directly on the hub body of the third clutch member. In such a configuration, if the second clutch plates on the hub body were to undergo slight axial displacement during operation of the clutch device when the clutch is opened and closed, wear would occur on the hub body, which could lead to chatter marks or the like. Such chatter marks would then counteract a sliding and smooth axial displacement of the clutch plates on the hub body of the third clutch member during operation of the clutch device. Rough or uneven sliding of the clutch plates could ultimately lead to a deterioration of the sensitive metering capability of the clutch device.

It is also provided, according to further aspect of the invention, that the sleeves are each provided, at an end region associated with the pressure-receiving plate, with a groove-shaped recess extending in the circumferential direction, in which respective radially outer plate-segment-shaped regions of the device for axially fixing the sleeves engage. This device may be the device for setting a back torque between the third clutch member and the first clutch member, so that this configuration simultaneously achieves functional integration and the sleeves are axially fixed to the hub body by means of the device. By this, it no longer is necessary to fix the sleeve bodies by means of other members, such as pins, cotter pins, or the like. In addition to this advantageous functional integration mentioned above, this also reduces the manufacturing costs of the clutch device according to the invention, because such pins or cotter pins otherwise would have to be fixed in the locating holes of the hub body, thus demanding additional machining steps.

It is also provided, according to still another aspect of the invention, that the second clutch member has a tubular section extending in the direction of the clutch pressure plate, on the outer circumference of which (tubular section) a tubular bearing sleeve of predetermined working length is provided. The bearing sleeve includes a radially outwardly extending circular collar with an abutment surface, on which abutment surface a spring device is arranged, which spring axially loads or pushes the third clutch member and limits the path of axial displacement of the third clutch member relative to the second clutch member. Such a configuration ensures that the selection of the spring stiffness of the spring device allows the level of the back torque desired by the driver of the vehicle to be influenced, thus allowing the driver to adjust the clutch device selectively with respect to the permissible back torque. As soon as the permissible reverse torque and thus the level of the thrust or braking torque provided by the drive engine of the vehicle is reached (which can thus be selectively adjusted for the respective driver or the respective route—on which the vehicle equipped with the clutch device according to the invention is operated), the release path of the clutch device is released by the compression of the spring device, and thus the predefined slip condition in the plate pack is reached, which ensures that the further increase of the thrust or braking torque in the drive train of the vehicle is prevented. The spring stiffness of the spring device can be implemented, for example, by means of a selection of spring devices of different strength or thickness.

It is therefore also provided, according to a further aspect of this invention, that the spring device may be a disc-shaped spring or a diaphragm spring, the spring force of which can be predetermined by means of springs having different axial disc dimensions; and which springs influence the amount of the transmittable back torque before partial opening of the clutch device by means of an axial displacement of the third clutch member relative to the second clutch member. As mentioned above, the bearing sleeve has a predetermined working length; also that the spring force of the disc spring or disc spring can be influenced by predetermining the disc dimension.

It is provided according to yet another aspect of the invention that the predetermined working length of the bearing sleeve is determined between the abutment surface and a contact surface of the bearing sleeve, and the predetermined working length can be varied by means of different bearing sleeves in such a way that the amount of axial displacement of the third clutch member relative to the second clutch member can be determined by means of the sum of the axial disc dimension and the working length of the bearing sleeve. The amount of axial displacement of the third clutch member relative to the second clutch member provides the slip condition in the plate pack to prevent an undefined increase of the back torque, and thereby provides the anti-hopping function. By selecting the bearing sleeve with regard to the working length, and selecting the disc-shaped spring or diaphragm spring with regard to its dimensions, the response of the clutch device according to the invention can be influenced driver-selectively or distance-selectively with regard to the release path to a reverse torque, and the release path can still be kept constant in terms of its amount. A thinner spring leads, for example, to a lower spring force and thus to a lower back-torque before initiating the opening movement of the clutch to provide the slipping condition in the disk pack.

It has been explained hereinabove that the clutch device according to this invention has a setting device provided between the second clutch member and the third clutch member, which is intended for setting a back torque between the third clutch member and the first clutch member by means of an axial displacement of the third clutch member relative to the second clutch member. Also as mentioned above, the present invention also creates a functional integration by axially fixing the sleeves guiding the second clutch plates.

It is provided according to a further aspect of the invention that one of the ring elements is provided with recesses, on its front face associated with the other ring element, for receiving end faces of the sleeves. This results in a respective contact surface for the sleeves created by the recesses, which are thus axially fixed.

Finally, the invention also provides a motorcycle with a front wheel and a rear wheel and a drive motor and a clutch device as described above.

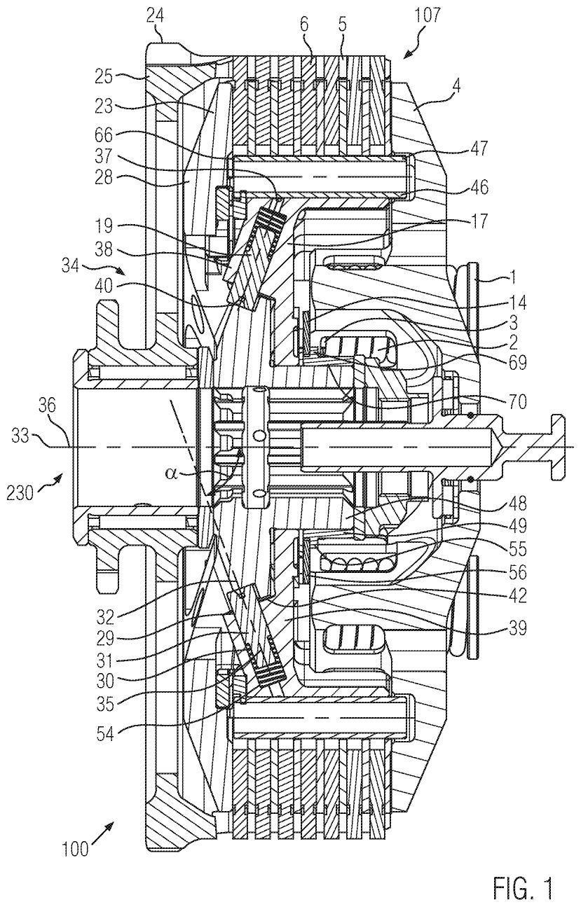

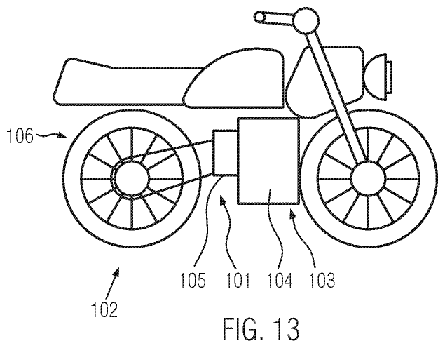

FIG. 1 of the drawing shows a longitudinal sectional view of a clutch device 100 in accordance with an embodiment of the present invention. The clutch device 100, as shown in the configuration shown, is intended to be fitted in a drive train 101 of a motorcycle 102, shown as an example of a vehicle in FIG. 13 of the drawing, for transmitting torque between a drive engine 103 (in the form of an internal combustion engine 104) and a gear change gearbox 105.

With the drive motor 103, a drive torque can be transmitted to the rear wheel 106 of the motorcycle 102 via the drive train 101, the motor 103 is then in traction mode. Then, when the motor 103 goes into thrust mode, a braking torque or thrust torque is transmitted from the motor 103 to the rear wheel 106, which must be transmitted from the rear wheel 106 opposite the contacted road surface, and can lead to an uncontrolled slip condition between the rear wheel 106 and the road surface and the motorcycle 102 goes into an uncontrollable driving dynamics condition.

Depending on the wishes of the user of the vehicle, a reverse or back torque from the rear wheel 106 via the drive train 101 to the engine 103 is desired, but a driving dynamic uncontrollable condition must be avoided. Therefore, high demands must be made on the anti-hopping function of the clutch device 100—a hopping or stamping rear wheel 106 must be avoided.

The clutch device 100 must therefore switch over in good time to the gaping mode providing a slip condition of the disk pack 107, so that an excessive reverse torque from the rear wheel 106 to the engine 103 is avoided, which would cause the risk of stamping of the rear wheel 106. A further requirement profile for the clutch device 100 is that it must provide a positive connection between a third clutch member 17 in the form of a driver, and a second clutch member 23 in the form of a driver, in order to start the internal combustion engine, for which purpose it is necessary that the positive connection between the two drivers 17, 23 must be provided at an angular speed of rotation of the clutch device 100 that is less than a clutch speed.

Clutch device 100 has a plurality of screw bolts 1 which serve to fix clutch pressure springs 2 and which, with the interposition of spacers 3, act on a clutch pressure plate 4, which acts on second clutch plates 5 in the form of steel plates and on first clutch plates 6 in the form of lining plates; the disk or plate pack 107 thus formed is pretensioned against the aforementioned second driver 23 (see also FIG. 4) as an abutment surface for torque transmission. In addition, the clutch device 100 has a first clutch member 25 in the form of a clutch basket with an external toothing 24 for clutch to the output side or primary drive side of the drive motor 103, and an internal gearing or toothing 230 formed on the second driver 23 for coupling to a transmission input shaft (not shown in detail) of the gear change transmission or gear change gearbox 105, the driver 23 having a longitudinal central axis 33.

As can easily be seen, the clutch device 100 also has a third clutch member in the form of the third driver 17, which is provided axially displaceable and rotatable relative to the second driver 23, and is provided with an internal recess 34 having a longitudinal center line 36. The longitudinal center line 33 of the second driver 23 and the longitudinal center line 36 of the internal recess 34 overlap each other and are approximately colinear.

The first and second clutch plates 5, 6 are slightly axially displaceable relative to the clutch basket 25 and are provided in arrangement overlapping each other to serve the torque transmission between the external toothing 24 and the internal toothing 230. Clutch pressure plate 4 is arranged adjacent to second driver 23, and serves to pressurize clutch plates 5, 6 of the disk pack 107 by means of the clutch pressure springs 2 already mentioned above.

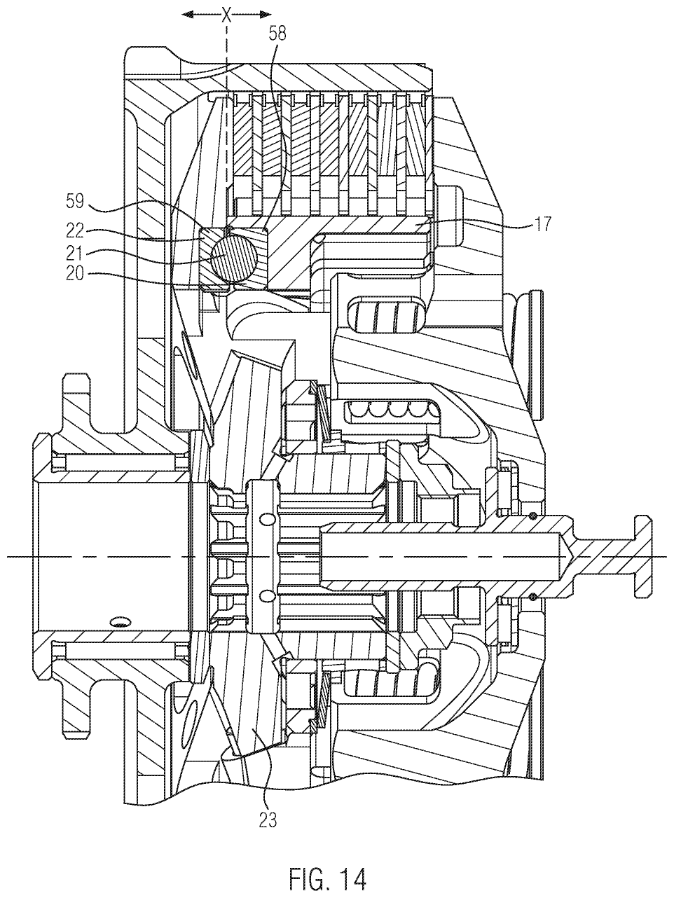

Clutch device 100 also has a setting device 20, 22 for setting the desired reverse torque, which can be seen in more detail in FIG. 14. This setting device is also used to create the air gap for setting the slip condition between the clutch plates 5, 6 to activate the anti-hopping function.

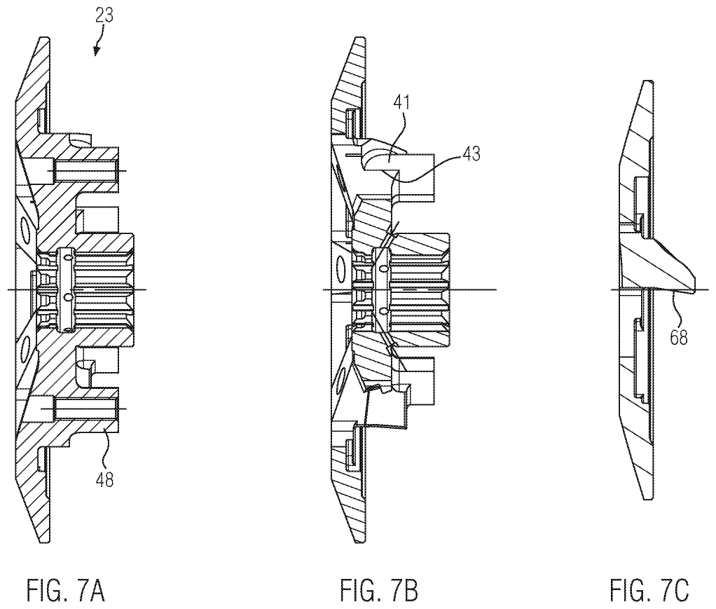

In addition, the clutch device 100 has an engagement device 19 provided between the second driver 23 and the third driver 17 to bring about a releasable engagement position between the two drivers 23 and 17, as a function of the angular speed of rotation of the third driver 17. The engagement device 19 has several pin bodies 31, which are arranged in locating bores 29 in the third driver 17, and which are loaded in the direction out of the locating bore 29 by means of respective compression springs 30 in order to achieve a positive engagement position with the second driver 23. The engagement device arrangement will be described later in more detail with reference to FIG. 7A. The respective pin bodies 31 each has a respective longitudinal center line 32, and each respective locating or reception bores 29 has a respective longitudinal center line 35, which are colinear or overlap each other in the illustrated design of the clutch device 100.

By means of the pin bodies 31, which can be axially displaced in the locating bores 29 along each longitudinal central axis 35, a positive engagement position between the third driver 17 and the second driver 23 is obtained, which is required to start the internal combustion engine in the form of the drive engine 103 of the motorcycle 102.

If the drive motor 103 is at a standstill, then the first clutch member, the clutch basket 25 driven to rotate via the external gearing 24, is also at a standstill; without the rotation of the drive motor 103 crankshaft, which is not shown in detail, the clutch basket 25 directly coupled to it is also at a standstill. In such a configuration, the pin bodies 31, loaded by the compression springs 30, are in their maximum outwardly displaced position relative to the bottoms of the locating bores 29, so that a positive engagement of the pin bodies 31 takes place in the respective engagement recesses 40 of the second driver 23, which can be seen more closely in FIG. 1. Via this positive engagement, a starting torque externally introduced via the internal gearing 230 of the second driver 23 can be transmitted from the driver 23 via the pin bodies 31 to the third driver 17, and via the plate pack 107 closed for torque transmission to the clutch basket 25, and thus to the external gearing 24; this ultimately transmits the starting torque to a gearing provided on the crankshaft of the engine, and leads to rotary actuation of the crankshaft.

For example, the starting torque can be transmitted via an external starting machine to the rear wheel 106 of the motorcycle 102, which is then transmitted via the drive train 101 to the transmission input shaft which is in positive engagement with the internal teeth 230 of the driver 23 of the second clutch member, and there applies the starting torque to the second driver 23. Similarly, a starting torque may also be transmitted to the internal combustion engine 103, for example, by means of a push start of the motorcycle 102 with the drive train 101 closed and engaged, or also, for example, by means of a conventional electric, hydraulic or pneumatic starting device which acts directly on the clutch device 100 for the starting process of the internal combustion engine 103 via an engagement for torque transmission from the starting device to the clutch device 100. For this purpose, for example, an engagement means not shown in detail may be provided on the clutch device 100 which is designed to transmit torque from the starting device to the clutch device 100. In all the above cases, the application of torque to the clutch device 100, with the engagement device 19 closed for starting, results in its positive rotary actuation and, via the clutch device 100, in turn in the rotary actuation of the crankshaft (not shown in detail) of the driving engine 103 at a speed exceeding the starting speed required for the automatic running of the engine 103, and finally in the starting and automatic running of the engine 103.

After starting the engine 103, the crankshaft speed rises significantly and via the increasingly faster rotating crankshaft the clutch device 100 is also rotated with increasing angular velocity. The increased rotary velocity of the clutch device 100 provides for the application to the pin bodies 31 of a corresponding centrifugal force, so that they are pressed deeper into the locating bores 29 against the action of the compression springs 30 until the pin bodies 31 finally emerge outwards from their respective engagement recesses 40 in the third driver 17 of the third clutch member. The positive engagement between the pin bodies 31 and the second driver 23 required to start the drive motor 103 thus is cancelled.

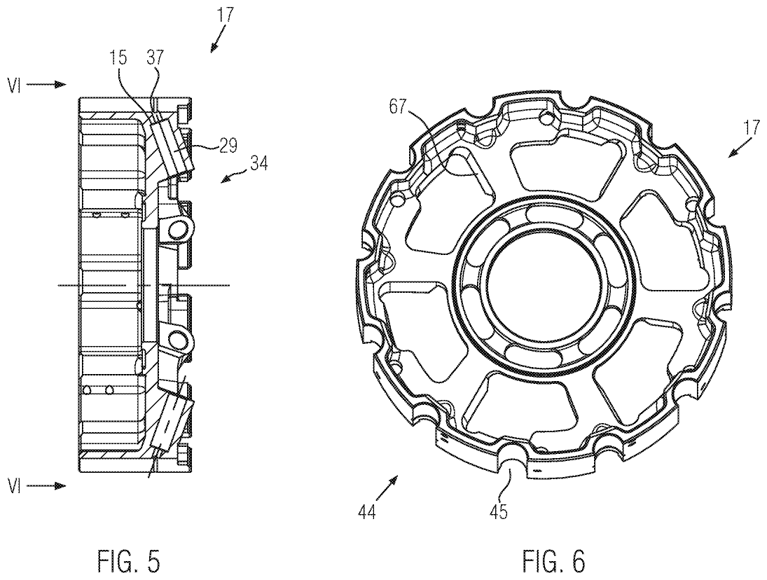

As can easily be seen from FIG. 1, the longitudinal central axis 35 of any locating bore 29 encloses or defines, with the longitudinal central axis 36 of the internal recess 34, an internal angle α of less than 90 degrees. The internal angle α in the example case shown in FIG. 1 is approximately 70 degrees, so that the reception or locating bores 29 (shown in more detail in FIG. 5), can be machined starting from the inner recess 34 of the third driver 17, i.e. can be produced, for example, by means of a drilling tool working radially outward relative to the longitudinal central axis 36. In this way a respective locating bore 29 can be created with a respective end section 15 (FIG. 5) that does not penetrate the outer contour of the driver 17 with the complete bore diameter. Accordingly, a locating bore 29 receives a respective compression spring 30 in such a way that the compression spring 30 can be supported at the end section 15 without the receiving bore 29 having to be closed off for this purpose from the outside (in the inward direction) with a closing body, as is the case with a known clutch device mentioned at the beginning. The respective passage 37 of a locating bore 29, as shown in FIGS. 1, 2 and 5 of the drawing, ensures that lubricant in the bore 29 can pass radially outwards (relative to central axis 36) through the passage 37, and that a lubricant cushion thus cannot form in the volume between the pin body 31 and the end section 15 of the bore 29.

The internal angle α can have values from inclusive 50 degrees to inclusive 80 degrees, preferably between 60 degrees and 80 degrees. By selecting a particular value for the internal angle α, the centrifugal force acting on the respective pin body 31 can also be modified. A larger internal angle of, for example, 80 degrees produces a greater centrifugal force effect acting on the respective compression spring 30 at a predetermined angular velocity of the clutch device 100 than a smaller internal angle of, for example, 60 degrees. In this way it is also possible, in addition to selecting appropriate compression springs 30 with a predetermined spring stiffness, to change the speed of the clutch device 100 by selecting the internal angle α, from which the engagement position of the pin bodies 31 with the locating bores 29 of the third driver 17 is brought about with decreasing angular velocity (and to influence the rotational speed from which the engagement position is released as the angular velocity of the clutch device 100 increases).

In the illustrated design of the clutch device 100, the locating bores 29 are formed in the area of a hub 38 of the third driver 17, starting from the inner recess 34. The plurality of bores 29 are evenly arrayed or arranged in the circumferential direction, so that a respective angular separation distance of about 60 degrees results between adjacent locating bores 29 in the circumferential direction of the hub 38.

As long as the clutch device 100 rotates at a rotational angular velocity which is greater than the rotational angular velocity at which the pin bodies 31 emerge from the engagement recesses 40 of the second driver 23, an engagement position between the pin bodies 31 and the engagement recesses 40 no longer takes place.

When the drive motor 103 is switched off, the speed of the crankshaft decreases, and at the same time the angular speed of rotation of the clutch device 100 decreases, thus reducing the centrifugal force with which the pin bodies 31 are loaded in the outward direction, i.e. in the direction into the locating holes or bores 29. This ensures that the pin bodies are gradually pressed out of the locating bores 29, in the direction toward the longitudinal center line 33, by the force of a corresponding compression spring 30 as the angular speed of rotation decreases; the pin bodies 31 thus gradually reach and enter the engagement recesses 40.

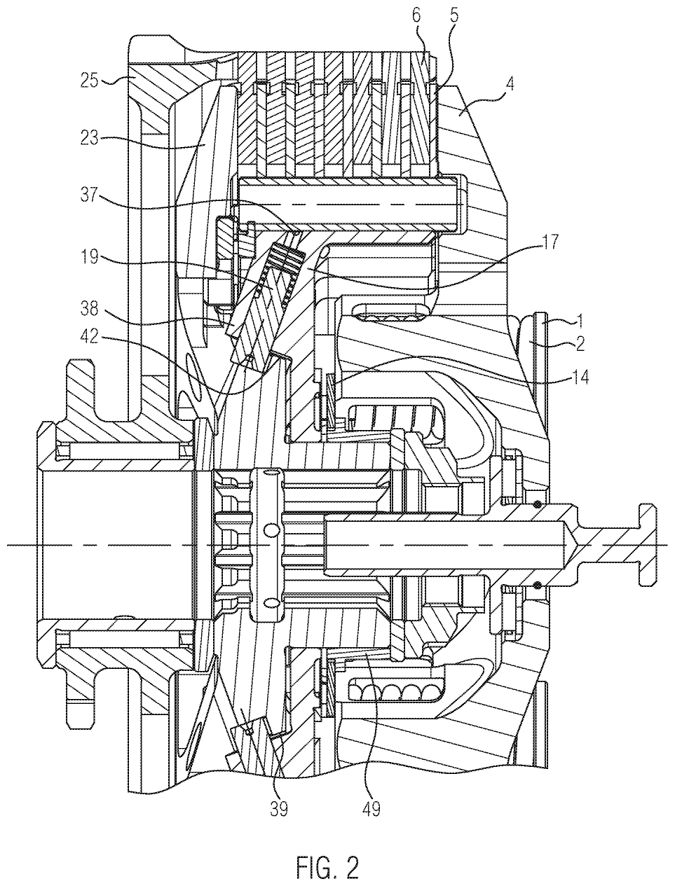

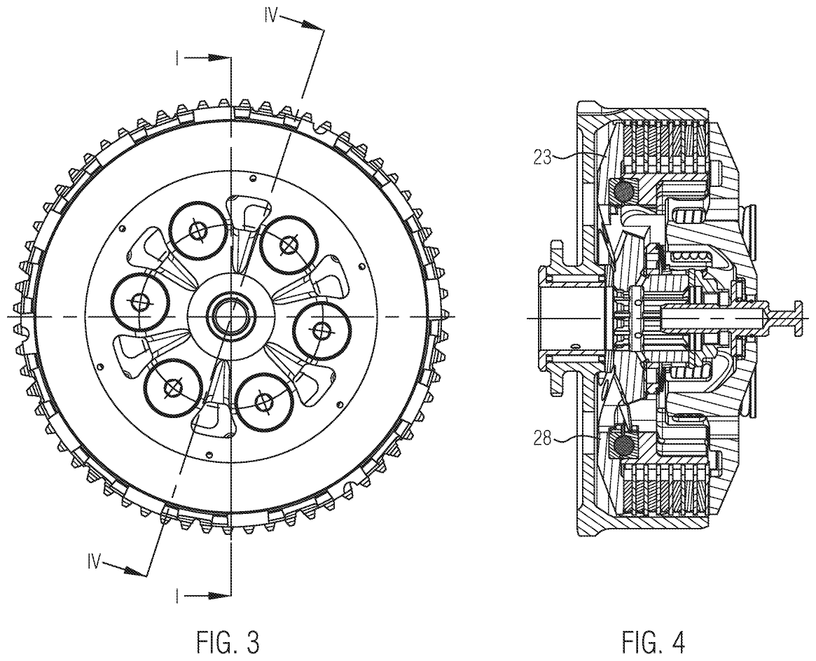

The engagement recesses 40 are each provided with a run-in chamfer 41, which can be seen in the lower illustration of FIG. 7B, in the area of an outer surface 42 (FIGS. 1 and 2) of a hub 39, which ensures that the run-in process of the pin bodies 31 into the engagement recesses 40 takes place without point loading and without high surface pressure. Chamfers 41 also promote that the contact between the outer surface of the cylinder of the respective pin bodies 31 and the respective stop surface 43 (FIG. 7B) of the engagement recesses 40 takes place in the form of a flat contact surface.

As can be seen from FIG. 6, the third clutch member's driver 17 has shaped surfaces 67, each defining an angle of preferably 9 degrees to a cross-sectional plane running at right angles to the longitudinal center line 36, which are engaged to shaped surfaces 68 provided on the second clutch member 23 (see FIG. 7C). This engagement occurs in such a way that during traction operation of the clutch device 100, a force is provided which acts on the third driver 17 in the direction of the second driver 23, the undercut thus formed thus ensuring the formation of a contact pressure between the shaped surfaces 67 of the third driver 17 and the shaped surfaces 68 of the second driver 23.

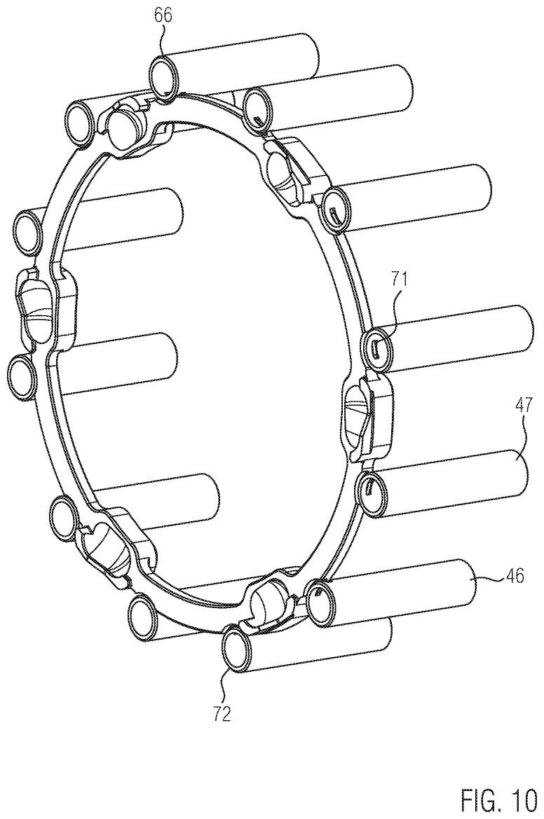

FIG. 6 of the drawing also shows that the third clutch member driver 17 has a cylinder-segment-shaped hub body 44, on the outer circumference of which are defined a plurality of longitudinal grooves 45, which are semi-circular in a cross-sectional view of the hub body 44. FIG. 10 depicts a sleeve body on a ring element. The longitudinal grooves 45 of the hub body 44 are used to accommodate the hollow cylindrical sleeves 46 seen in FIG. 1, and clearly shown in FIG. 10 of the drawing, on the outer surfaces 47 of which the second clutch plates 5 are slidably mounted so that they can move axially. This configuration ensures that the clutch plates 5, which are steel plates, cannot work their way into the hub body 44, which is made of a light alloy for example. Beneficially, the steel second clutch plates 5 cannot damage the hub body 44 during their axial movement relative to the hub body 44.

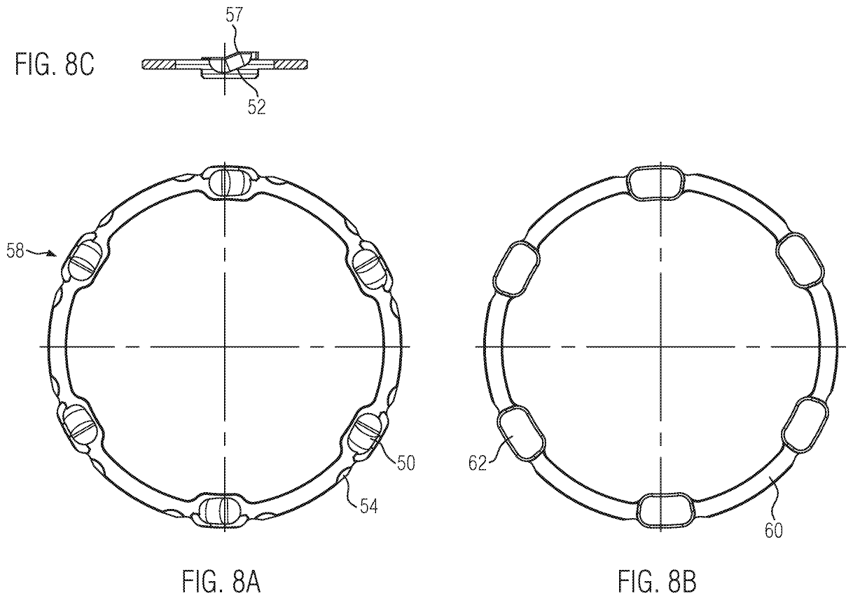

Combined reference to FIGS. 1 and 10 shows that the sleeves 46 of the sleeve body are each provided with a groove-shaped recess 71 extending in the circumferential direction at an end region 72 assigned to the second driver 23, in the form of a pressure-receiving plate 28 (FIGS. 1 and 4), in which radially outer plate-segment-shaped regions 54 (see FIG. 8A) are engageable for axial fixing of the sleeves 46. This configuration ensures functional integration, because the plate-segment-shaped areas 54 are formed on an element 20 of the device in the form of a ring element 58 (FIGS. 8A and 14)—which is at the same time a member of the device (including element 22) for axial displacement of the third driver 17 for setting the predetermined back torque and/or activating the anti-hopping function of the clutch device 100 according to the invention. This configuration also ensures a reduction of the members forming the clutch device 100, because possible spring pins or the like are not needed to fix the sleeves 46 alternatively, and therefore no mechanical machining of the third driver 17 to accommodate such spring pins or the like to fix the sleeves 46 is required.

As can be seen from FIGS. 1 and 7A of the drawing, the second clutch member's driver 23 has a tubular section 48, on the outer circumference of which a bearing sleeve 49 with a predetermined length is provided (as shown in FIG. 1 of the drawing). In addition, while also referring to FIG. 2, the bearing sleeve 49 has a radially outwardly extending circular collar 55, on which an abutment surface 69 is formed, on which a spring device in the form of a disc-shaped or diaphragm-shaped release spring 14 is arranged. The release disengaging spring 14 can be used to pressurize or bias the third driver 17 and limit the path of axial displacement of the driver 17 relative to the second driver 23. Moreover, the spring stiffness of the disengaging spring 14 can influence the opening behavior of the clutch device 100 when the anti-hopping function is activated. The strength or thickness of the disc-shaped spring or diaphragm spring comprising the disengaging spring 14 can be used to influence its spring stiffness (spring constant). The spring 14 can influence the transmittable back torque before the clutch is set to the predetermined slip state by this release process, via an axial displacement of the driver 17 relative to the driver 23; this is accomplished by applying pressure to the clutch pressure plate 4 via this release process and the axial displacement of the driver 17, and thus slightly opening the disk or plate pack 107 to reduce the back torque that can be transmitted within the plate pack 107 and thus avoiding an uncontrolled driving condition known as stamping of the rear wheel 106. In this way, the transmittable reverse torque desired by means of the clutch device 100 according to the invention can be influenced driver-selectively or track-selectively.

The bearing sleeve 49 has a predetermined working length, which is determined between the abutment surface 69 and a contact surface 70 of the bearing sleeve 49 (FIGS. 1 and 2), and the desired transmittable back torque can be kept constant in terms of amount by means of bearing sleeves 49 with different working lengths, taking into account the thickness or strength of the disengaging spring 14, which can assume different values, as already explained above. A spring 14 with a higher spring stiffness leads to a later onset of the displacement movement of the third driver 17 than a spring device with lower spring stiffness. However, taking into account the sum of the axial disc dimension of the disengaging spring 14 and the working length of the bearing sleeve 49, the total displacement path of the third driver 17 can be kept constant; thus, the amount of the total transmittable back torque likewise can be kept constant even with different response behavior.

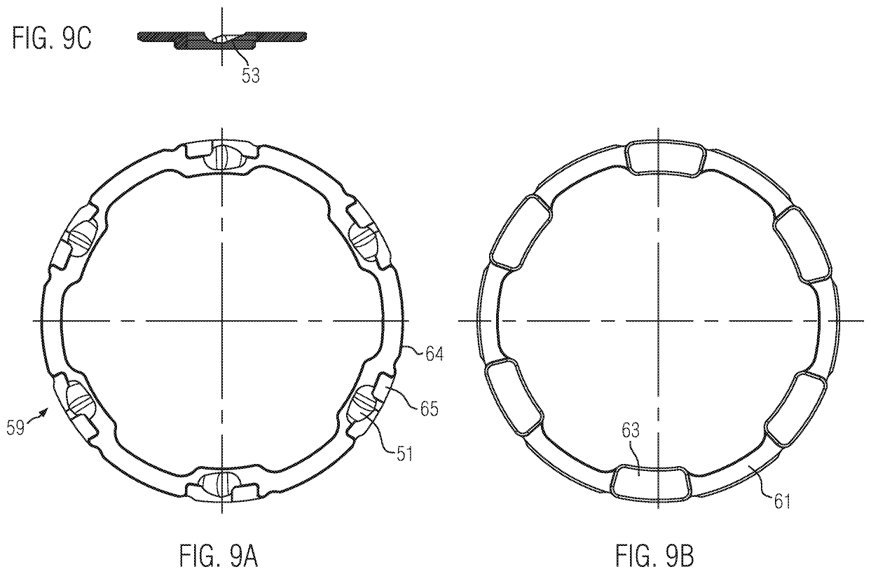

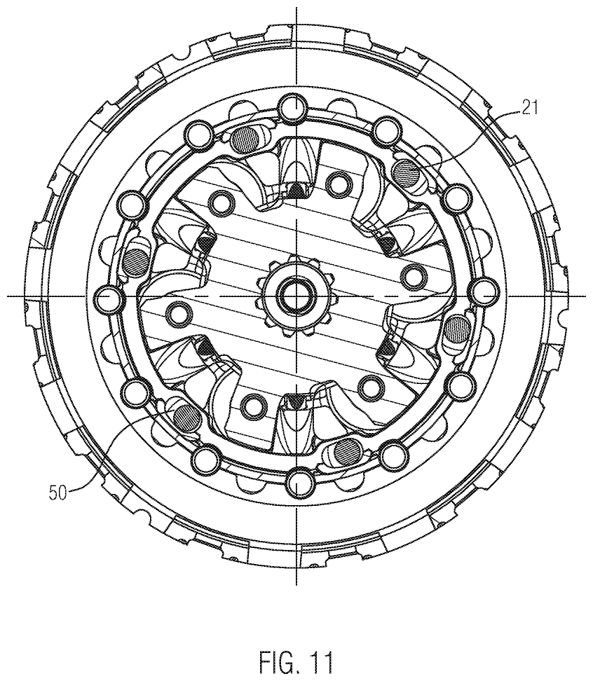

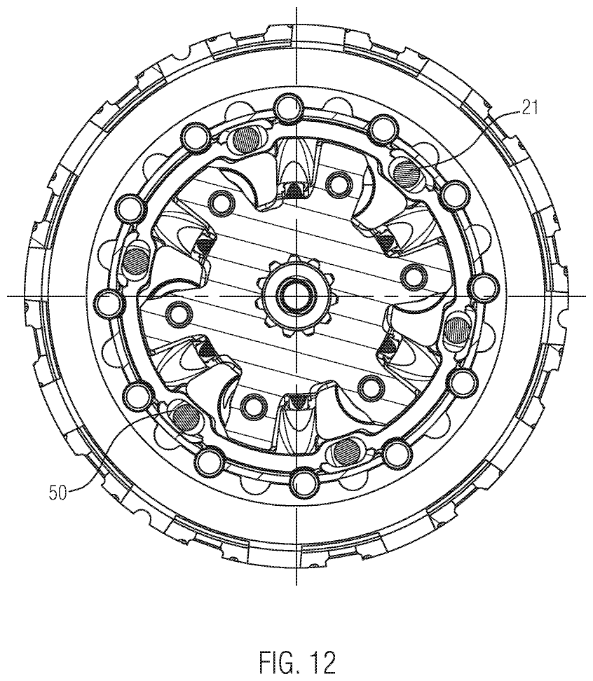

There now is described further the detail of the setting device facility or assembly 20, 22. Referring to FIGS. 8A-B and 9A-B of the drawing, the setting device 20, 22 has first and second ring elements 58, 59 each provided with associated ramp segments 50, 51; see also FIGS. 11 and 12. FIG. 14 of shows that the setting device portion 20 is supported by the third driver 17 and the setting device portion 22 is supported by the second driver 23, and that the balls 21 shown are located between the two device portions 20, 22; see also FIGS. 11 and 12 showing ramp portions 50 and balls 21. The device portion 20 has a ring element 58, which can be seen more closely in FIGS. 8A, B, and C of the drawing, with ramp segments 50 for receiving the balls 21 and ball ramps 52 arranged in the area of the ramp segments 50. Similarly, the second device portion 22 shown in FIGS. 9A, B, and C of the drawing has a ring element 59 with ramp segments 51 for receiving the balls 21 and ball ramps 53 arranged in the area of the ramp segments 51.

The ring elements 58, 59 are rotatable relative to one another. The respective ball ramps 52, 53 are configured to rise in circumferentially opposite directions such that when the ring elements 58, 59 are rotated in the same direction, the clearance distance between the ramp segments 50, 51 is smaller than when the ring elements 58, 59 are rotated in opposite directions. The opening behavior of the clutch can be influenced by the slope of each of the surfaces of the ball ramp 52 and/or 53. A larger angle of the ramp surface or surfaces causes the clutch to open or release only at a higher back torque than at a smaller or flatter angle. This means that with a larger angle, more engine braking torque or thrust torque can be transmitted via the rear wheel than with a smaller ramp surface angle. By this configuration, when the third and second drivers 17, 23 rotate in the same direction, the distance between the two ring elements 58, 59 remains the same, whereas when the two drivers rotate in opposite directions, the clearance distance between the two ring elements 58, 59 increases. Again, reference may also be made to FIGS. 11 and 12 of the drawing.

While FIG. 11 shows the position of the balls 21 in the ramp segment 50, the balls 21 are located on the left-hand edge of the respective ramp segment 50; this corresponds to the position of the balls 21 when the two ring elements 58, 59 are rotated in the same direction. FIG. 12 shows the position of the balls 21 in the ramp segments 50 when the two drivers 17, 23 are rotated in opposite directions.

The opposite rotation of the third and second drivers 17, 23 takes place when a reverse torque is introduced into the clutch device 100 via the drive train 101. The reverse torque is supported within the clutch device 100 via the plate pack 107 on the two drivers 17, 23 and thus ensures that the two drivers 17, 23 rotate in opposite directions relative to each other. The spring pins 31 are not in engagement with the engagement recesses 40, as the clutch device is in engagement between the spring pins 31 and the engagement recesses 40 at a speed far above the speed required to bring about the engagement position.

Because the two ring elements 58, 59 are supported on the two correspondingly associated drivers 17, 23, as shown in FIG. 14, and in a rotationally fixed configuration in each case, this relative rotation in opposite directions, which takes place at a small angle of rotation, causes the balls 21 to roll on the ball ramps 52, 53, which rise in opposite directions. In this way the clearance distance “X” (FIG. 14) between the two ring elements 58, 59 is changed, e.g. enlarged, and thus there is an axial displacement of the third driver 17 relative to the second driver 23. As can be seen from FIGS. 8A and 8C, the ring element 58 has, in the area of each ball ramp 52, radially outwardly raised segments 57, which prevent the balls 21 from escaping from the ramp segment area. This axial displacement of the driver 17 ensures that an axial force acting on the clutch pressure plate 4, and acting along the longitudinal central axis 33, is generated. This reduces the surface pressure between the clutch plates 5, 6 and thus creates a slip condition in the plate pack 107 and therefore reduces the reverse torque that can be transmitted in the plate pack 107; as a result to this, the rear wheel 106 can roll on the road surface without an uncontrolled slip condition arising between the rear wheel 106 and the road surface.

If the thrust torque provided by the engine is reduced, e.g. by the driver of the vehicle ensuring that the engine returns to traction by operating a throttle valve, i.e. by introducing a driving torque into the clutch device, the relative angle of rotation between the ring elements in opposite directions is reduced, the clearance distance “X” becomes smaller, the slip condition in the disk pack 107 is reduced or eliminated, and the clutch device can feed the driving torque provided by the engine into the gear change gearbox or transmission.

To bring about a rotationally fixed, positive-locking connection between the ring elements 58, 59 and the functionally associated two drivers 17, 23, the first ring element 58 has, in the region of the rear side 60, engagement elements 62 (FIG. 8B) which form a positive-locking connection with recesses on the third driver 17 which are of complementary shape and surface (but which are not shown in more detail). Similarly, the second ring element 59 has, on the rear side surface 61, engagement elements 63 (FIG. 9B) which form a positive-locking connection with recesses on the second driver 23 (which also are not shown in more detail). A torque transmission between the ring elements and the drivers can therefore take place via the respective positive locking connection. Consequently, a reverse torque introduced via the rear wheel leads to an axial displacement of the third driver 17 against the action of the disengaging spring washer 14 and to the creation of the air gap within the disk pack 107 as previously described.

As can also be seen from FIG. 9A, the ring element 59 has recesses 65 on a front face 64 assigned to the ring element 58 in the installation position, which are provided to receive end faces 66 of the sleeves 46 (FIG. 10), the sleeves 46 are thus supported on the recesses 65 and in this way a functional integration is achieved, as additional abutment elements are not necessary to support the sleeves 46.

With regard to features of the invention not explained in detail above, explicit reference is made to the patent claims and the drawing.

### LIST OF REFERENCE SIGNS

1. screw bolt
2. clutch pressure springs
3. spacer
4. clutch pressure plate
5. second clutch plate
6. first clutch plate
14. spring device
15. end section
17. carrier
19. engagement device
20. device
21. ball
22. device
23. driver
24. external gearing
25. first clutch member, clutch basket
28. pressure mounting plate
29. mounting hole
30. compression spring
31. pin body
32. longitudinal center axis
33. longitudinal center axis
34. internal recess
35. longitudinal center axis
36. longitudinal center axis
37. passage
38. hub
39. hub
40. engagement recess
41. inlet chamfer
42. outer surface
43. locating face
44. hub body
45. longitudinal groove
46. sleeve
47. outer surface
48. section
49. bearing sleeve
50. ramp segment
51. ramp segment
52. ball ramps
53. ball ramps
54. plate segment-shaped area
55. circulation collar
56. disc-shaped spring, disc spring
57. segment
58. ring element
59. ring element
60. rear surface
61. rear surface
62. engagement element
63. engagement element
64. front surface
65. recess
66. front surface
67. forming area
68. forming area
69. abutment surface
70. contact surface
71. groove-shaped recess
72. end range
100. clutch device
101. power train, drive train
102. motorcycle
103. drive motor
104. internal combustion engine
105. gear change gearbox
106. rear wheel
107. plate pack
230. internal gearing

What is claimed is:

1: A clutch apparatus for a vehicle, which is intended to be arranged in a drive train for transmitting torque between a drive engine and a gear change gearbox of the vehicle, comprising:
a first clutch member (25) for coupling with the output side of the drive engine;
a second clutch member (23), having a longitudinal central axis (33), for coupling to the gear change gearbox;
a third clutch member (17) axially displaceable and rotatable relative to the second clutch member (23), with an inner recess (34) having a longitudinal central axis (36) corresponding to the longitudinal central axis (33) of the second clutch member;
at least one first clutch plate (6) together with the first clutch member (25), the at least one first clutch plate rotatable and axially displaceable relative to the first clutch member;
at least one second clutch plate (5) together with the third clutch member (17), the at least one second clutch plate rotatable and axially displaceable relative to the third clutch member and overlapping with the first clutch plate (6);
a pressure-receiving plate (28) on the second clutch member (23) and supporting the first (6) and second (5) clutch plates;
a clutch pressure plate (4) adjacent to the second clutch member (23) and adapted to pressurize the first (6) and second (5) clutch plates;
a plurality of clutch pressure springs (2) for pressurizing the clutch pressure plate (4) relative to the pressure receiving plate (28);
a setting device (20, 22), between the second clutch member (23) and the third clutch member (17), for setting a back torque between the third clutch member (17) and the first clutch member (25) by an axial displacement of the third clutch member (17) relative to the second clutch member (23);
an engagement device (19) between the second clutch member (23) and the third clutch member (17) for providing a releasable engagement position between the second clutch member (23) and the third clutch member (17) as a function of the rotational angular velocity of the third clutch member (17), wherein the engagement device (19) has at least one pin body (31), the pin body having a longitudinal central axis (32), and the at least one pin body being displaceably arranged in a receiving bore (29) of the third clutch member (17) and biased by a compression spring (30) in the direction of the engagement position, and wherein the longitudinal central axis (32) of the at least one pin body (31) coincides with a longitudinal central axis (35) of the receiving bore (29); and
wherein the setting device (20, 22) comprises a first ring element (58) and a second ring element (59) rotatable relative to one another, the first and second ring elements each comprising respective first and second ramp segments (50, 51), and with balls (21) arranged between the ramp segments (50, 51); and
wherein the respective first and second ramp segments (50, 51) have respective first and second ball ramps (52, 53) rising in circumferentially opposite directions such that, when the ring elements (58, 59) rotate in the same direction, a clear distance between the first and second ramp segments (50, 51) is smaller than when the ring elements (58, 59) rotate in opposite directions.

2: The clutch device (100) according to claim 1 wherein the first ring element (58) comprises segments (57) arranged radially outwardly in a region of the first ball ramps (52), extending along a respective partial region of a circumferential extent of the first ball ramps (52), and projecting in a height direction of the first ring element (58).

3: The clutch device (100) according to claim 2 wherein the first and second ring elements (58, 59) comprise, on respective spaced-apart rear side surfaces (60, 61) thereof, first and second engagement elements (62, 63) for engagement in recesses of the second (23) and third (17) clutch members, which recesses are complementary in shape and contour.

4: The clutch device (100) according to claim 3 wherein the second ring element (59) comprises, on a front face (64) associated with the first ring element (58), recesses (65) for receiving end faces (66) of sleeves (46).

5: The clutch device (100) according to claim 1 wherein the pin body (31) is arranged so that the longitudinal central axis (32) of the pin body (31) forms an internal angle (α) of less than 90 degrees with the longitudinal central axis (33) of the second clutch member (23).

6: The clutch device (100) according to claim 1 wherein the receiving bore (29) has a passage (37) in a radially outer region of the receiving bore, which passage provides for the passage of lubricant, and movement of the pin body (31) and the compression spring (30) acting on the pin body (31) through the passage (37) is prevented by the radially outer region.

7: The clutch device (100) according to claim 1 wherein a plurality of pin bodies (31) are arranged on a hub (38) of the third clutch member (17) starting from the inner recess (34), and are releasably engageable with respective engagement recesses (40) arranged on a hub (39) of the second clutch member (23).

8: The clutch device (100) according to claim 7 wherein at least one of the engagement recesses (40) is provided with an entry chamfer (41), on an outer surface of the hub (39), formed at an angle to the longitudinal central axis (33) of the second clutch member (23), and merging into a stop surface (43) of the at least one engagement recess (40).

9: The clutch device (100) according to claim 1 wherein the third clutch member (17) has shaped surfaces (67) arranged at an angle to a cross-sectional plane extending at right angles to the longitudinal central axis (36), which shaped surfaces (67) engage with other shaped surfaces (68) provided at another angle to the second clutch member (23) so that, during traction operation of the clutch device (100), a force acts on the third clutch member (17) in a direction of the second clutch member (23).

10: The clutch device (100) according to claim 1 wherein the third clutch member (17) has a cylinder-segment-shaped hub body (44) on an outer circumference of which are defined a plurality of longitudinal grooves (45), each of the grooves is circular-segment-shaped in a cross-sectional view of the hub body (44), and wherein the grooves receive hollow cylindrical sleeves (46) on the outer surfaces (47) of which the second clutch plates (5) are axially displaceably arranged.

11: The clutch device (100) according to claim 10 wherein the sleeves (46) are each provided, at an end region associated with the pressure-receiving plate (28), with a groove-shaped recess extending in a circumferential direction, into which engages a corresponding radially outer plate-segment-shaped region (54) of the setting device (20) for axially fixing the sleeves (46) engage.

12: The clutch device (100) according to claim 1 wherein the second clutch member (23) has a tubular portion (48) extending in a direction of the clutch pressure plate (4), on an outer circumference of which a tubular bearing sleeve (49) of a predetermined working length is disposed, the bearing sleeve comprising a radially outwardly extending rotating collar (55) having an abutment surface (69) on which a spring device (14) is arranged, which spring device (14) axially biases the third clutch member (17) and limits a path of axial displacement of the third clutch member (17) relative to the second clutch member (23).

13: The clutch device (100) according to claim 12 wherein the spring device (14) comprises a diaphragm spring, a spring force of which is predeterminable by selecting an axial disc dimension for the diaphragm spring, and the diaphragm spring influences an amount of a transmittable back torque, before partial opening of the clutch device (100), by an axial displacement of the third clutch member (17) relative to the second clutch member (23).

14: The clutch device (100) according to claim 13 wherein the predetermined working length of the bearing sleeve (49) is determined between the abutment surface (69) and a contact surface (70) of the bearing sleeve (49), and the predetermined working length is variable by means of different bearing sleeves (49) in such that an amount of the axial displacement of the third clutch member (17), relative to the second clutch member (23), is determined by a sum of the axial disc dimension for the diaphragm spring and the working length of the bearing sleeve (49).

15: The clutch device (100) according to claim 1 wherein the receiving bore (29) is disposed relative to the inner recess (34) such that the longitudinal central axis (35) of the receiving bore (29) forms an internal angle of less than 90 degrees with the longitudinal central axis (36) of the inner recess (34).

16: The clutch device (100) according to claim 5 wherein the internal angle (α) has a value in the range of 50 degrees to 80 degrees inclusive.

17: A motorcycle having a front wheel, a rear wheel, and a drive motor, and comprising a clutch device (100) according to claim 2.
